(19) United States
(12) Patent Application Publication
(10) Pub. No.: US 2016/0152369 A1
(43) Pub. Date: Jun. 2, 2016

(54) LABELING MACHINE FOR LABELING PRODUCTS TO BE LABELED

(71) Applicant: SACMI VERONA S.P.A., Imola (IT)

(72) Inventors: Maurizio PEDERCINI, Marmirolo (IT); Matteo GRIONI, Castellucchio (IT); Alessandro GAZZINI, San Benedetto Po (IT)

(73) Assignee: SACMI VERONA S.P.A., Imola OT (IT)

(21) Appl. No.: 14/904,838

(22) PCT Filed: Jul. 14, 2014
(86) PCT No.: PCT/IB2014/063089

§ 371 Date: Jan. 13, 2016

(30) Foreign Application Priority Data
Jul. 16, 2013 (IT) VR2013A000162
Jul. 16, 2013 (IT) VR2013A000163
Feb. 28, 2014 (IT) VR2014A000052

(51) Int. Cl. B65C 9/08; B65C 9/26; B65C 9/00

(52) U.S. Cl. CPC B65C 9/08; B65C 9/0006; B65C 9/26

(57) ABSTRACT

A labeling machine having a feeder assembly for a backing ribbon that supports a plurality of labels, includes an assembly for applying the labels on the products to be labeled, and an assembly for taking up the backing ribbon. The feeder assembly includes at least two feeder spools and a device for the automatic splicing of the backing ribbons. The takeup assembly includes a first cutting device, a first splicing device and at least two winding elements. The splicing device is intended to perform the splicing between a first splicing region and a second splicing region, the first cutting device being intended to cut the backing ribbon at the portion that extends between the first splicing region and the backing ribbon wound onto the first winding element.

### TECHNICAL FIELD

The present disclosure relates to a labeling machine for labeling products to be labeled.

### BACKGROUND

Conventional labeling machines use labels applied to a backing ribbon from which they must be removed to be placed on products to be labeled.

These labeling machines have a ribbon feeding assembly constituted by at least one spool of ribbon, which supports the labels and is unwound progressively.

The ribbon unwound from the feeder spool is transferred to a label application assembly, which has a device intended to separate the labels from the ribbon and to apply them on the products to be labeled.

Finally, the backing ribbon is rewound on a takeup spool.

When the takeup spool is full, the labeling machine is stopped, the backing ribbon is cut, the full spool is removed from the core of the winding body and the cut ribbon is attached to the core of the winding body.

It is evident that known solutions have the drawback that it is necessary to stop the labeling machine periodically in order to remove the spool full of backing ribbon to connect manually the cut backing ribbon to the core of the winding body.

Backing ribbon takeup assemblies are also known which unload the ribbon into bags or containers.

When a first bag is full of backing ribbon, the assembly cuts the incoming backing ribbon and directs it into a second bag arranged at the side of the first bag.

These takeup assemblies also have drawbacks, among which mention is made of the large volume occupied by the backing ribbon taken up, with the consequent problems linked to its disposal.

The aim of the present disclosure is to solve the problems and obviate the drawbacks described above, providing a labeling machine for labeling products to be labeled that is considerably easier and more practical to use than conventional machines.

### SUMMARY

Within the scope of this aim, the disclosure provides a labeling machine that avoids the need to be stopped periodically during its use.

The disclosure also provides a labeling machine that allows limiting the space occupation of the backing ribbon taken up.

The disclosure further proposes a labeling machine for labeling products to be labeled that is extremely reliable.

### BRIEF DESCRIPTION OF THE DRAWINGS

Further characteristics and advantages of the disclosure will become more apparent from the description of some preferred but not exclusive embodiments of a labeling machine for labeling products to be labeled according to the disclosure, illustrated by way of non-limiting example in the accompanying figures, wherein:

FIG. 1 is a schematic view of a labeling machine for labeling products to be labeled;

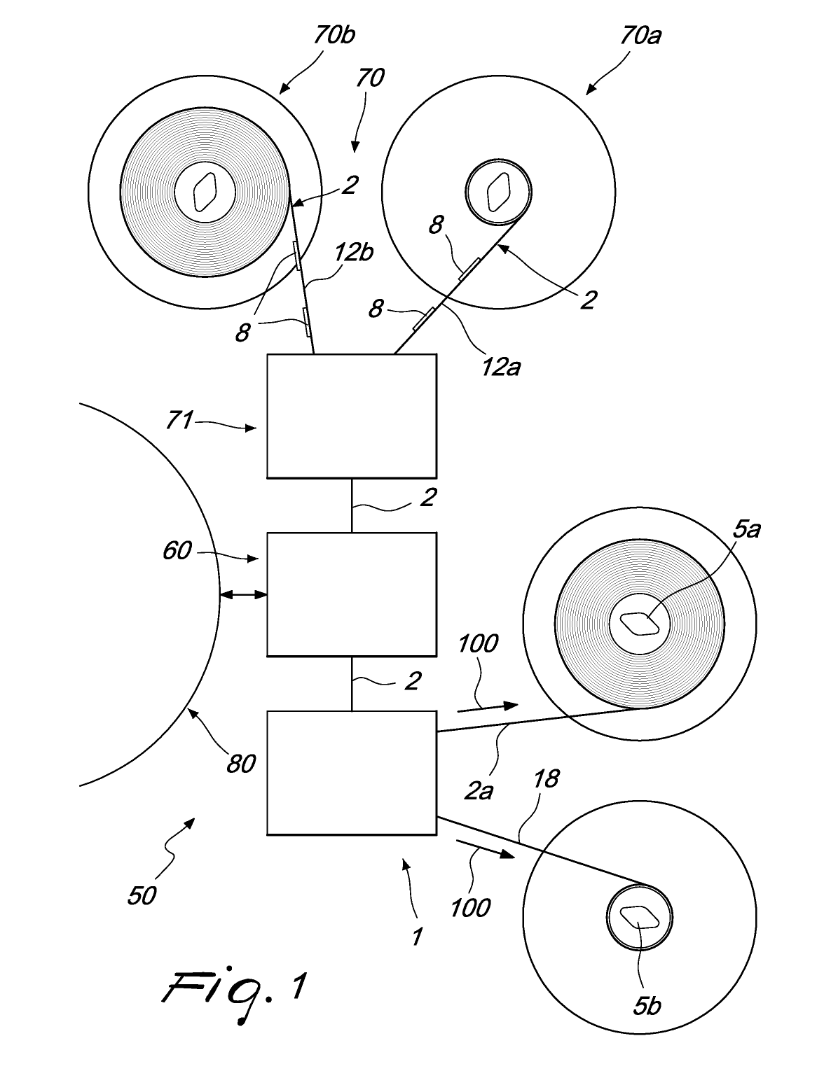

FIG. 2 is a schematic view of the takeup assembly;

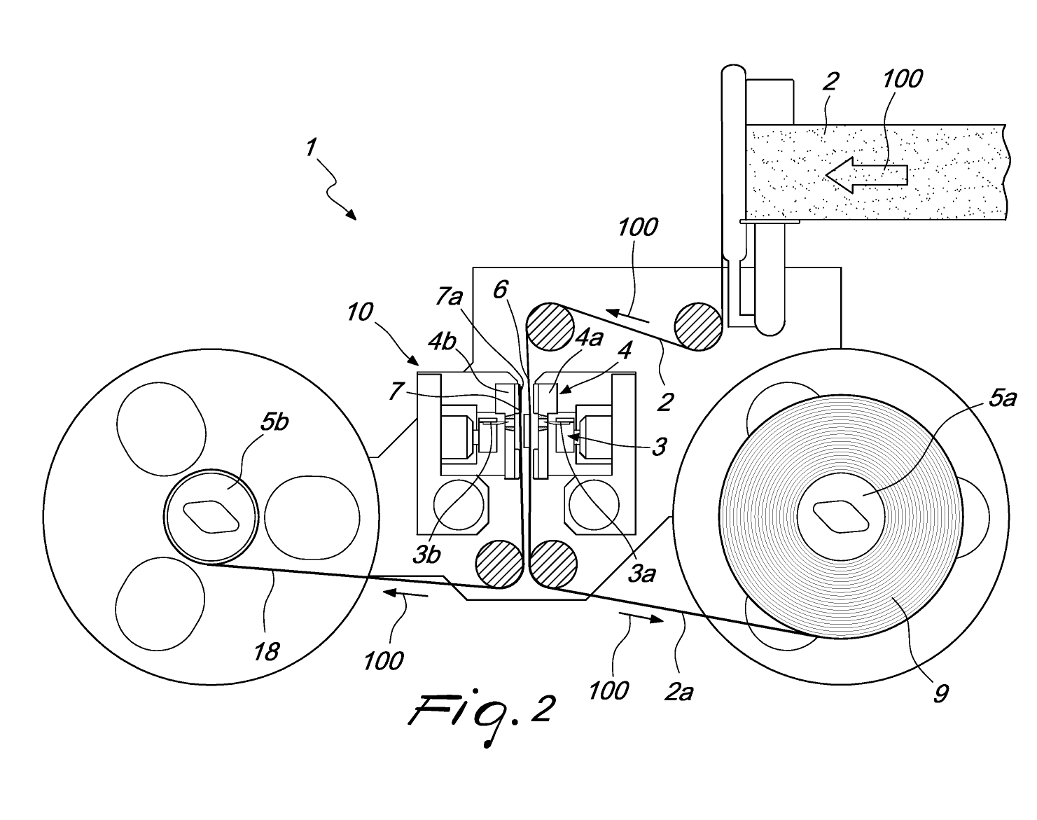

FIG. 3 is a schematic view of the feeder assembly; and

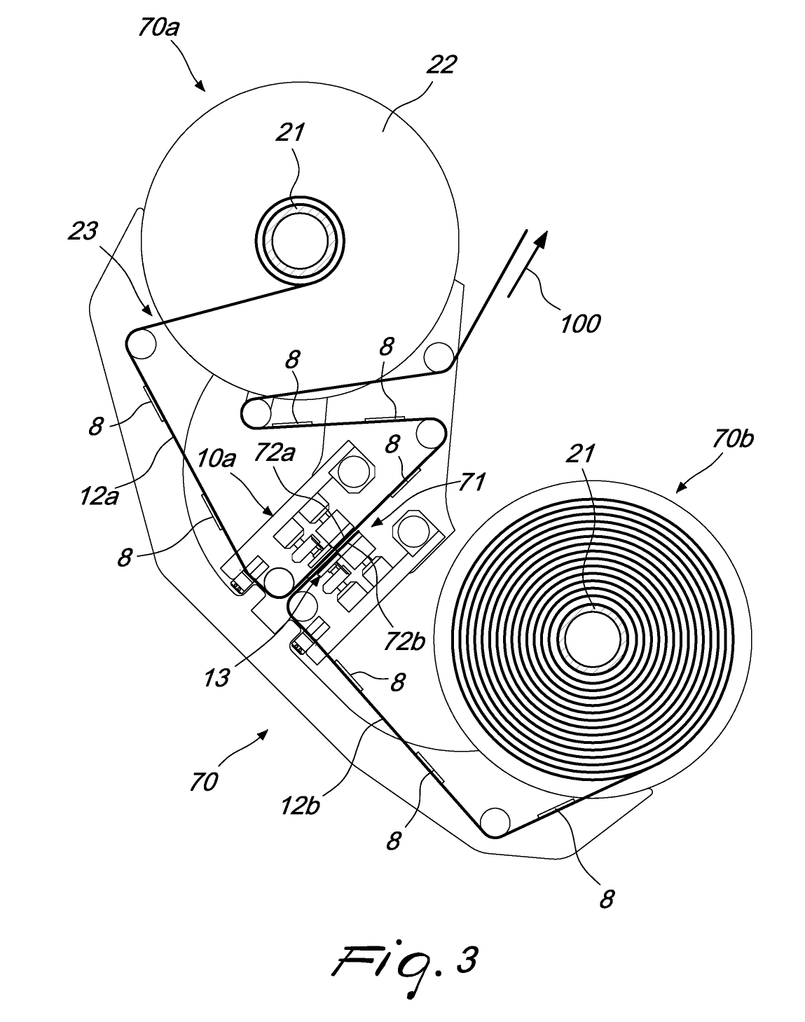

FIG. 4 is an enlarged-scale view of the first cutting and splicing station shown in FIG. 2.

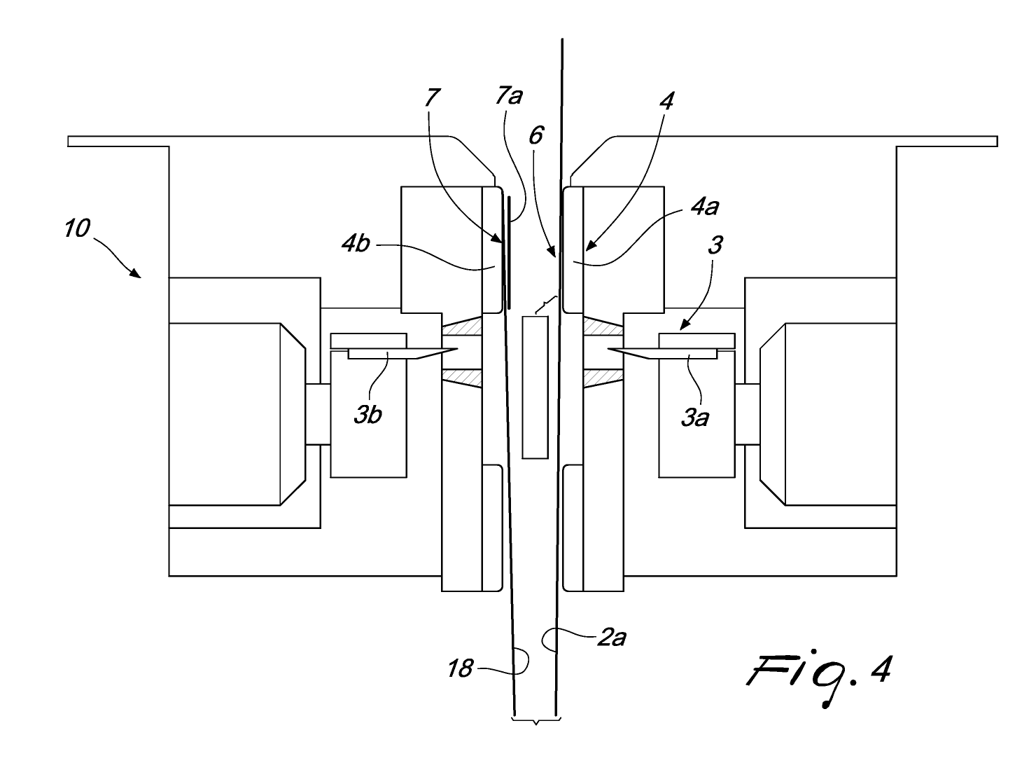

In the examples of embodiment that follow, individual characteristics, given in relation to specific examples, may actually be interchanged with other different characteristics that exist in other examples of embodiment.

### DETAILED DESCRIPTION OF THE DRAWINGS

With reference to the cited figures, the present disclosure relates to a labeling machine, generally designated by the reference numeral 50.

The labeling machine 50 comprises a feeder assembly 70 for a backing ribbon 2 that supports a plurality of labels 8, an assembly 60 for applying the labels 8 supported by the backing ribbon 2 on products to be labeled, and an assembly 1 for taking up the backing ribbon 2.

Typically, the application assembly 60 is associated functionally with a device 80 for supplying the containers to be labeled.

Conveniently, the feeder assembly 70 comprises at least two feeder spools 70a, 70b and a second device 71 for the automatic splicing of the backing ribbons 12a, 12b of the labels 8 unwound from the feeder spools 70a, 70b.

The takeup assembly 1 comprises a first cutting device 3, a first splicing device 4 and at least two winding elements 5a, 5b for the backing ribbon 2.

The first splicing device 4 is intended to perform on command the splicing between a first splicing region 6, obtained from a backing ribbon 2 being wound onto a first winding element 5a, and a second splicing region 7, which is formed on a connection element 18 that is connected to a second winding element 5b.

The first cutting device 3 is intended to cut on command the backing ribbon 2 at the portion 2a that extends between the first splicing region 6 and the backing ribbon 2 already wound onto the first winding element 5a.

In order to allow the cutting device 3 to cut the portion 2a equally if the backing ribbon 2 is wound onto the first winding element 5a or onto the second winding element 5b, a first cutting blade 3a and a second cutting blade 3b are provided and are arranged on opposite sides with respect to the path of the backing ribbon 2.

Depending on whether the portion 2a to be cut is the one being wound onto the first or second winding element 5a, 5b, the first blade 3a or the second blade 3b is actuated selectively.

According to a preferred embodiment, the takeup assembly 1 comprises a first cutting and splicing station 10.

Said first cutting and splicing station 10 is arranged upstream of the winding elements 5a and 5b along the advancement direction 100 of the backing ribbon 2 and supports the first cutting device 3 and the first splicing device 4.

Preferably, the first cutting device 3 is adapted to cut the backing ribbon 2 simultaneously or after the splicing between the first splicing region 6 and the second splicing region 7 by the first splicing device 4.

Conveniently, the second splicing region 7 comprises a double-adhesive sheet-like element 7a associated with the connecting element 18 and arranged on the face of the connecting element 18 that faces the first splicing region 6.

Advantageously, the first splicing device 4 comprises a pair of pads 4a, 4b adapted to move into mutual contact the first splicing region 6 and the second splicing region 7.

Advantageously, the takeup assembly 1 is provided with a device for accumulating the backing ribbon 2, which is constituted for example by guiding elements and/or dandy rolls, which can be moved on command

The accumulation device is arranged upstream of the cutting device 3 and of the splicing device 4.

The winding elements 5a, 5b comprise, or are associated with, a respective central body.

The central body is connected kinematically to an actuation motor to allow the winding of the backing ribbon 2 around the central body.

Preferably, the connection element 18 is connected to the central body.

By way of example, the connecting element 18 can be constituted by a portion of ribbon or film that has a first free end locked on the central body, while the other free end forms the second splicing region 7.

Conveniently, the winding elements 5a, 5b are supported by a supporting frame on opposite sides with respect to the first cutting and splicing station 10.

Advantageously, the takeup assembly 1 is associated functionally with a first device for detecting a parameter related to the spool 9 wound around the winding elements 5a, 5b.

By way of example, this parameter can be constituted by the radius of the spool 9 being wound on the winding element 5a.

The first detection device, in particular, is adapted to control, once it has detected that this parameter has reached a preset value, the splicing device 4 and the cutting device 3, actuating at the same time the movement of the other winding element 5b.

Advantageously, the feeder assembly 70 comprises a second automatic splicing device 71 and at least two feeder spools 70a, 70b for the backing ribbon 2.

In particular, the second automatic splicing device 71 is intended to perform, on command, the splicing between a first joining region, designated by the reference numeral 72a and formed on a first backing ribbon 12a being unwound from a first feeder spool 70a, and a second joining region, designated by the reference numeral 72b and formed on a second backing ribbon 12b wound onto a second feeder spool 70b.

The first backing ribbon 12a supports a plurality of adhesive labels 8, which are arranged, mutually spaced, on the face directed toward the second joining region 72b.

The second backing ribbon 12b also supports a plurality of adhesive labels 8, which are arranged, mutually spaced, on the face that is opposite the one on which the second joining region 72b is formed.

Conveniently, the end of the first backing ribbon 12a is associated with a central core 21.

Said end is connected, for example by means of adhesive tape, to the central core 21, which is supported rotatably by a supporting disk 22 of the first feeder spool 70a.

However, nothing forbids the provision, in some applications, of the movement, by motor means, of the central core 21 about the unwinding axis of the spool of ribbon 12a: in this case, the central core 21 conveniently rotates rigidly with the supporting disk 22.

According to a preferred embodiment, the first joining region 72a comprises at least one portion 23 of the first ribbon 12a that is free from self-adhesive labels 8 and is arranged substantially at the end of the first backing ribbon 12a associated with the first feeder spool 70a.

Conveniently, the feeder assembly 70 comprises a second cutting device 13, which is adapted to cut on command the portion 23 free from self-adhesive labels upstream of the first joining region 72a with respect to the advancement direction, designated by the arrow 100, of the first backing ribbon 12a.

Preferably, the cut is performed directly upstream of the first joining region 72a with respect to the advancement direction 100.

Advantageously, the feeder assembly 70 has a cutting and splicing station, designated by the reference numeral 10a in the figures, which supports the second cutting device 13 and the second automatic splicing device 71.

The feeder assembly 70 is associated functionally with a second device for detecting a parameter relating to the first backing ribbon 12a that is unwound from the first feeder spool 70a.

In particular, the second detection device is adapted to control the second automatic splicing device 71 once said parameter has been detected.

Preferably, the second detection device is adapted to detect the portion 23 of the first ribbon 12a that is free from self-adhesive labels 8.

In practice, the labeling machine 50 comprises a feeder assembly 70, an application assembly 60 and a takeup assembly 1 of a backing ribbon 2 of labels 8.

The feeder assembly 70 comprises at least one feeder spool 70a, 70b of the backing ribbon 2 that supports the labels 8, while the takeup assembly 1 comprises at least one winding element 5a or 5b.

The or each feeder spool 70a, 70b is arranged upstream of an assembly 60 for applying the labels 8 to products to be labeled, while the or each winding element 5a or 5b is arranged downstream of the application assembly 60.

The takeup assembly 1 comprises a first splicing device 4, which is adapted to connect the head of the backing ribbon that arrives from the application assembly 60 to the tail of a connection element 18 that leads to the winding element 5b.

In particular, the first splicing device 4 comprises:
a path for a first ribbon;
a path for a second ribbon that faces the path of the first ribbon;
means for joining a portion of the first and second ribbons;
a first cutting device 3 for cutting selectively the first or the second ribbon 2.

In particular, the first and second backing ribbons follow the paths synchronously and the first cutting device 3 is arranged downstream of the first splicing device 4 in the advancement direction of the backing ribbons.

The labeling machine 50 according to the disclosure makes it possible to work continuously both for feeding and for takeup.

The operation of the labeling machine 50 according to the disclosure is evident from what has been described above.

During the operation of the labeling machine 50, the backing ribbon 12a or 12b with the self-adhesive labels 8 applied thereto is transferred to the application assembly 60, which detaches the labels 8 from the backing ribbon 12a, 12b to apply them on the containers.

When the second detection device, constituted for example by the second sensor arranged upstream of the second splicing and cutting station 10a, detects the absence of labels 8 and therefore the portion 23 of the first ribbon 12a that is free from self-adhesive labels 8, it actuates the second splicing device 71, which splices, and optionally cuts, the first backing ribbon 12a, splicing it with the second backing ribbon 12a previously preset and wound on the second winding element 70b.

Downstream of the application assembly 60, the backing ribbon 2, from which the labels 8 have been detached, is wound around the first winding element 5a.

When the first detection device detects that the radius of the spool 9 being wound around the first winding element 5a has reached a preset size, it actuates the first cutting and splicing station 10, which splices and cuts the backing ribbon, splicing it with the connecting element 18 previously preset and connected to the other winding element 5b.

In this manner, by actuating rotationally the second actuation element 5b, it is possible to continue taking up the backing ribbon 2 without stopping the labeling machine

A labeling machine 50 has thus been obtained which can operate in a completely continuous manner.

All the characteristics of the disclosure indicated above as advantageous, convenient or the like may also be omitted or be replaced by equivalents.

The individual characteristics described with reference to general teachings or to particular embodiments may all be present in other embodiments or may replace characteristics in these embodiments.

In practice it has been found that the disclosure is capable of achieving fully the intended aim and objects in all of its embodiments.

The disclosure thus conceived is susceptible of numerous modifications and variations.

In practice, the materials used, so long as they are compatible with the specific use, as well as the shapes and dimensions, may be any according to the requirements.

All the details may furthermore be replaced with other technically equivalent elements.

The disclosures in Italian Patent Applications no. VR2013A000162, no. VR2013A000163 and no. VR2014A000052, from which this application claims priority, are incorporated herein by reference.

1-10. (canceled)

11. A labeling machine comprising a feeder assembly for a backing ribbon that supports a plurality of labels, an assembly for applying said labels on products to be labeled, and an assembly for taking up the backing ribbon, wherein said feeder assembly comprises at least two feeder spools and a second device for the automatic splicing of the backing ribbons of the adhesive labels unwound from said feeder spools and wherein said takeup assembly of the backing ribbon comprises a first cutting device, a first splicing device and at least two winding elements for said backing ribbon, said splicing device being intended to perform on command the splicing between a first splicing region, obtained from a backing ribbon being wound onto a first winding element, and a second splicing region, which is formed on a connection element that is connected to a second winding element, said first cutting device being intended to cut on command said backing ribbon at the portion that extends between said first splicing region and the backing ribbon wound onto the first winding element, so as to allow the continuous splicing of the backing ribbon of the adhesive labels unwound from the feeder spools and of the backing ribbon being wound onto the winding elements.

12. The labeling machine according to claim 11, further comprising a first cutting and splicing station that supports said first cutting device and said first splicing device.

13. The labeling machine according to claim 11, wherein said first cutting device is adapted to cut said backing ribbon simultaneously or after the splice between said first splicing region and said second splicing region on the part of said first splicing device.

14. The labeling machine according to claim 11, wherein said second splicing region comprises a double-adhesive sheet-like element associated with said connecting element and arranged on a face of said connecting element that is arranged so as to face said first splicing region.

15. The labeling machine according to claim 11, wherein said first splicing device comprises a pair of pads adapted to move mutually into contact said first splicing region and said second splicing region.

16. The labeling machine according to claim 11, further comprising a device for accumulating the backing ribbon arranged upstream of said first cutting device and of said first splicing device.

17. The labeling machine according to claim 11, wherein said at least two winding elements comprise a respective central body that is connected kinematically to an actuation motor in order to allow the winding of the backing ribbon around said central body.

18. The labeling machine according to claim 17, wherein said connection element is connected to said central body.

19. The labeling machine according to claim 11, wherein said takeup assembly is associated functionally with a first device for detecting a parameter related to a spool that is being wound around a winding element, said first detection device being adapted to actuate, once it has been found that said parameter has reached a preset value, said first cutting device, said first splicing device and the rotation of the other winding element.

20. The labeling machine according to claim 19, wherein said parameter comprises a radius of said spool.
